(19) United States
(12) Patent Application Publication
(10) Pub. No.: US 2009/0317761 A1
(43) Pub. Date: Dec. 24, 2009

(54) Stabilizer for tooth prostheses

(76) Inventors: Pieter Van Der Veken, Mortsel (BE); Andre Jozef Ernest Vander Kerken, Antwerpen (BE)

Correspondence Address: COLLARD & ROE, P.C., 1077 NORTHERN BOULEVARD, ROSLYN, NY, 11576, US

(21) Appl. No.: 12/456,397

(22) Filed: Jun. 16, 2009

(30) Foreign Application Priority Data
Jun. 20, 2008 (DE) 10 2008 029 086.6

(51) Int. Cl. A61C 13/28

(52) U.S. Cl. 433/172

(57) ABSTRACT

A stabilizer for tooth prostheses, consisting of a double torsion spring, the arms (4, 5) of which are telescopically longitudinally movable in cylindrical guides (7, 8) in the prosthesis halves (1, 2), has a hook-shaped eyelet (9) on each of the ends of both of the stabilizer arms. The guides (7, 8) are closed on their external insertion ends, except for a narrow insertion slot (15) in the form of a mailbox slot, in the assembled functional position of the stabilizer in the prosthesis parts, the eyelets (9) and the eyelet planes and accordingly the planes of the stabilizer arms are directed perpendicular to the longitudinal extension of the insertion slot (15). It is thereby achieved that the stabilizers (3) or their arms cannot slip out of the guides (7, 8) and overall their assembly and disassembly can be easily and rapidly undertaken without the aid of any tools.

The invention relates to a stabilizer for tooth prostheses according to the preamble of claim 1, an auxiliary device according to claim 13, and a method according to claim 15.

Such stabilizers for tooth prostheses are already known in a plurality of embodiments. These primarily consist of two arms that are swivelingly connected by a joint and pushed apart by spring elements, by means of which arms the upper and lower prosthesis parts are connected to each other on both sides (right and left).

Document DE 195 46 960 C2 teaches of a stabilizer for tooth prostheses in which both of the two stabilizer arms are connected to each other in a spring-loaded manner by means of a joint provided with a torsion spring. Each of the free ends of the arms is screwed to the exterior of the prosthesis part. In so doing, the stabilizers are arranged and dimensioned in such a manner that their joints are located on or after their rearward ends of the prosthesis parts. In this way, although the arms of the stabilizers are arranged in an unchangeable position on the prosthesis parts, they cannot follow the natural movement of the teeth or mandible because the natural swiveling of the human lower jaw occurs at a point farther back in the head.

This is disadvantageous given how complicated repairs are in the instance of wear or breakage of the stabilizer parts, for example the breakage of a spring. Proper repair cannot be quickly and easily effected by the wearer of the prosthesis, but rather by a dental technician only since the screwed connection of the prosthesis arms can be unscrewed only with special tools.

Document EP 1 046 380 A1 teaches of a stabilizer for tooth prostheses that is designed similarly to the previously described stabilizer, wherein the upper arm is designed to be able to elongate telescopically and its outer end is bolted to the prosthesis part, while the lower arm, provided on its outer end with a sliding block, is provided in a longitudinally movable manner by means of a guide groove in the lower prosthesis part.

Greater freedom of movement of the stabilizers and thus of the upper and lower prosthesis parts toward each other is indeed achieved herewith, which makes it possible to carry out natural movement more easily. However, this tooth stabilizer consists of a relatively great number of individual parts, presenting an increased susceptibility to failure. Moreover, the arms are here too movably arranged on the exterior sides of the prosthesis parts, meaning that movement may cause a disturbing sensation or even pinching of the skin on the inside of the cheek. Furthermore, the entirety of the stabilizers is visible on the outside of the prosthesis, which some wearers of prostheses consider aesthetically displeasing and unacceptable.

Finally, document WO 2007/016753 teaches of a stabilizer for tooth prostheses that is composed of only one two-armed torsion spring, wherein the stabilizer arms are simultaneously the long, curved ends of the torsion spring that are movably arranged so as to telescope and axially glide in cylindrical guides of the prosthesis parts. Owing to the floating movability in the longitudinal guides, the arms can now glide, if necessary, so that each half of the prosthetic can move naturally toward the other half. The stabilizer parts, or at least the arms, are also largely protected from direct contact with aggressive agents. Moreover, the overall wearing comfort is substantially increased since the movable arms of the stabilizer parts are no longer in direct contact with the inside of the cheeks of the wearer of the prosthesis. Because of the possibility of an optimal curved design or guiding of the stabilizer arms in the correspondingly designed guides, e.g. in the lower prosthesis half corresponding to a curve of Spee (curve that is modeled on the shape of the profile form of the row of teeth), while the upper arm or the guide in the upper prosthesis half likewise has an arc radius of special design, it is possible when the mouth is opened or closed or when the chin is moved up and down that the stabilizer arms optimally glide in the guides without impeded movement or friction that can be perceived as disturbing.

Disadvantageous, however, is that the smooth stabilizer arms are located practically loosely movably in the guide bore so that upon removal of the prosthesis parts the arms slip out of the guides, resulting in the risk of the stabilizers dropping out and not or (in particular for hygienic reasons) no longer being able to be inserted without prior re-assembly. Moreover, saliva and food particles as well can enter the relatively long guides, the cleaning of these relatively narrow blind hole guide bores being either not possible or only possible with great difficulty. In order to avoid this, the stabilizers are, from their spring joint to the guide bores, coated in plastic or are embedded in plastic bushes that, however, tear easily and additionally limit the flexibility of the centric coil spring part.

The object of the invention is thus to provide a stabilizer for tooth prostheses of the abovementioned type, which stabilizer is easily and securely designed, assembled, fitted or refitted by the dental technician, or with which fitting or refitting by the dental technician as well as wearing comfort and hygiene (for the wearer) is ensured, which stabilizer is also easily self-inserted or self-exchanged and does not fall apart by itself. A method shall furthermore be stated for ensuring simple and economical positioning of the embedded guides by the use of a simple and easy-to-handle auxiliary device.

This object is solved by a stabilizer for tooth prostheses with the characterizing features of claim 1. Advantageous developments are characterized in the corresponding appended subclaims.

According thereto, the guides for the stabilizer arms are frontally closed (to prevent falling apart) from their outer insertion ends to a narrow narrowing, for example a narrow insertion slot in the style of mailbox slot (but also a latch, a spring-loaded pin, an elastic membrane or generally known locking elements). The ends of the spring ends are furthermore outfitted with extensions, for example flat extensions in the style of an eyelet, loop, or elbow (potentially with inserted flat part of a knob) or of a ball or the like, shaped and dimensioned in such a manner that they can be inserted, flatly or with little latch resistance, through the narrowing or through the insertion slot of the guides.

It is therefore advantageous if the narrowings or the insertion slots of the guides and the flat extensions or eyelets of the spring arms are designed or arranged in such a manner that in the integral operational position of the stabilizers, the extensions/eyelets or eyelet ends are arranged approximately perpendicular (preferably about 90°±20°) to the longitudinal extension of the narrowings or the insertion slots or the like. It is significant that through the particular arrangement of the insertion slots, the stabilizer arms do not slip out of the prosthesis parts in an unintended manner, in particular when the prosthesis is not in the mouth. In order to return or insert the stabilizers into the respective guides of the prosthesis parts, the stabilizers or their arms must be pushed through the insertion slot in the position perpendicular to the operational position in order thereafter to be swiveled by approximately 90° so as to be brought into their operational position.

It goes without saying that other known structural solutions for limiting the removal path of the spring arms can be used, such as, for example, a ball end of the spring arm and a slit elastic membrane, or an outward-pointing hook (open or closed) on the spring arm end and an exterior step interacting therewith on the insertion end of the guide slit.

This provides the great advantage that individual wearers of the prosthesis can personally easily and simply exchange or even completely remove the stabilizers of their prosthesis as needed without tools, in so far as the prosthesis is at least disturbing the wearer or is broken, because the prostheses can routinely be exchanged.

The optimal handling of the stabilizer is particularly important during wearing if, for example, a foreign body gets trapped and wedged in the space between the spring and the dental prosthesis. The prosthesis can then be removed by the wearer subsequent to which, by turning the spring barrel that acts as a type of handhold, the spring arms can be screwed out of the prosthesis or swung horizontally and removed. The prosthesis can thereafter be immediately used again as a customary dental prosthesis without fasteners or spring-loaded stabilizers, and all with minimal handholds and movements and no tools.

The guides for the stabilizer arms can be provided as simple, correspondingly long bores in the body of the prosthesis, positioned from the rear side of the prosthesis, the opening in this instance then being designed as closed with a corresponding insertion slot on the removal or insertion side formed by a small panel or similar or by the appropriate application of sundry materials or a closing element such as a latch in order to provide an operational insertion slot in the style of a mailbox slot or a similar narrowing. The positioning, in particular the subsequent positioning of correspondingly curved guide bores is, however, very complex to carry out. The insertion slot, as previously described, must thereafter also be provided with an appropriate material application also as an additional slotted small panel. It is therefore particularly advantageous if the guides are provided as tubular guide bushes that are embedded in the prosthesis material in such a manner that the faces of their external insertion ends terminate in the rear side of the individual prosthesis ends, preferably flush thereto or therewith. In each instance, a guide bush is inserted into or embedded in correspondingly large curved recesses as guides in the support material of the prosthesis part, which guide bushes have a size and shape designed to correspond with the desired guide or position of the stabilizer arm. This makes it possible to dispense with all relatively complex labor, these guide bushes already being provided with their one open end closed on the required insertion slot (narrowing).

It must also be recognized that these guide bushes are longitudinally, that is to say in the direction of the row of teeth, insertable into a correspondingly positioned bore. However, there is the additional simplifying possibility of inserting these guide bushes into laterally positioned tubular recesses and thereafter refilling or filling the remaining intermediate spaces with corresponding material in such a manner that this action remains as good as invisible. Since these bent recesses or grooves are thus so easily laterally positioned from the outside, for example by milling or grinding, the retroactive positioning of the guide bushes is quickly and neatly possible with no further problems.

The eyelets or hooks of the spring arms of the stabilizer can be bent in the same plane as the spring arm, that is to say spring arms and their eyelets are positioned substantially in the same plane. That means, in turn, that in the integrated state in which the entirety of the stabilizer comes to rest in a vertical plane, the respective eyelets likewise are situated in this same vertical plane. This also means that the insertion slots on the guide bushes, which are known to be provided perpendicular to the direction of the eyelets, are also provided in the corresponding horizontal direction. After the ventilation openings or the ventilation tubes on the guide bushes protrude horizontally in the integrated state, the insertion slot is to be arranged or provided in that same direction, which also implies a simplification in their design. In this way, the insertion slot also simultaneously acts as a sliding bearing during lateral movement of the dental prosthesis.

It is advantageous if an approximately bead-shaped pellet (ball, spherical cap, cylinder, oval) is respectively securely fixed near (e.g. at a distance of 2 to 3 mm) the eyelets on the spring arms. The pellets composed of glass, plastic or stainless steel are marginally thicker than the width of the mailbox slot, preferably 0.2 to 0.3 mm. They form a latch in such a manner that the slot (or the pellet or both) elastically deforms upon removal. This causes the spring arms not to glide out should the dental prosthesis parts flap apart completely leading to the possible tipping of the spring arms in such a manner that the eyelets are directed parallel to the insertion slots, but rather the spring arms remain inside with the pellet on the slot. With the application of light pressure, the pellet can be pulled through the slot subsequent to which the entire spring arm can be pulled out. Likewise with the application of light pressure, the spring arm can thereafter be reinserted anew.

Manufacturing is simplified if the eyelets together with the beads associated therewith are designed as a separate unit that is slid or firmly clamped onto the straight (simply truncated) arm ends. When closed eyelets or partially closed eyelets/hooks are on the ends of the spring arms, it can be provided to prevent falling out that these eyelets/hooks are designed as minimally wider than the length of insertion slots and can elastically be pressed together in the transverse direction thereof. The removal or insertion of the arms through the insertion slots thus occurs under light tension or pressure, elastically snapping into or out of place.

It is particularly advantageous if the guide bushes are plastic tubes whose interiors (in the integrated state) present at least one, preferably three, holes or radially lateral openings arranged in the longitudinal direction of the tube, which holes are connected to the exterior side of the prosthesis parts, through which connection cleaning and ventilation holes are formed. Thus, saliva or even food particles having entered the guide bores can exit again through the lateral ventilation holes. Moreover, in the care of the dental prosthesis in its removed state, the guide bores can be properly rinsed so that no food particles or saliva remains in the guides for a long period of time and decays, which can lead to halitosis, inter alia.

Advantageously, the ventilation holes can also be managed on the inside of the mouth (tongue side) so that a suction effect from the inside of the mouth, blowing through, spraying through or with brush and rinsing allows for a more effective cleaning process.

In that the guide bush can already be designed in the shape of a plastic tube, it is now possible to provide the radial openings by positioning corresponding plastic tubes. Of course subsequent to the positioning of the guide bushes it would be possible to place corresponding tubes in the radial direction for the ventilation holes. It would, however, make more sense and be considerably easier to combine into one integrally formed structure the respective plastic tubes, that is to say those of the guide bush and those of the ventilation holes, thereby forming a comb-shaped or bilaterally toothed guide rack. This makes possible a relatively fast and simple as well as secure refitting of dental prostheses with stabilizers.

It is advantageous to increase wearing comfort, prevent possible problems from arising owing to direct contact with the metal joint of the stabilizer, and to prevent or substantially reduce in particular the possibility of food particles becoming stuck or accumulating in the joint windings of the torsion springs of the stabilizers if the coil spring part, that is to say the joint part, is axially held or enveloped by a plastic spool. This plastic spool can substantially consist of two flange parts that are in the style of a snap fastener, can be pressed together axially, and can be locked in place or bonded. Accordingly, the spring flange parts closely envelop the exterior or front face of the spring, and the spiral windings of the stabilizer spring are axially held together at a predetermined measurement. Through the flat, slightly bowed, rounded head section of such a plastic spool, and through contact with the cheek, the position is stabilized and the wearing comfort is substantially increased. The surface and curvature of the plastic spool correspond approximately to the lateral surfaces of a molar. During assembly, the plastic spool additionally serves as a relatively secure and comfortable handhold.

The design according to the invention of the guide bush in the style of guide rack also has the advantage that it is very readily, simply, and securely handleable upon its insertion facilitated by means of a corresponding auxiliary device (according to claim 12).

According to the invention, an auxiliary device is moreover provided with which the guide rack(s) are held or fixed by their lateral rinsing or ventilation tubes and are laterally inserted into the slot in the prosthesis part and held until embedding with additional material has been securely effected. This auxiliary device advantageously consists substantially of a holding part or handhold on whose front end, for example on a flange part arranged perpendicularly thereon, two rows of retaining gudgeons protrude perpendicular to the flange part while simultaneously being provided in a parallel arrangement to each other, while having the same number and same distance from one another as the rinsing tubes (one-sided) on the guide tubes. The gudgeons have substantially the same exterior measurements as the interior measurements of the rinsing holes and are also adjusted thereto with regard to length. By means of its rinsing hole tubes, the guide rack is thus attached on the gudgeons of the auxiliary device and can be easily positioned in the appropriate position in the prepared channel in the prosthesis part by a dental technician using the abovementioned auxiliary device.

It is furthermore advantageous that both guide bushes or the guide bushes of both prosthesis parts, that is to say the upper and lower parts, of one prosthesis side can be positioned at the same time. Two rows of retaining gudgeons having corresponding spacing and a curved arrangement are provided for this purpose. For those individuals who are larger and accordingly have relatively higher sets of teeth, a third row of retaining gudgeons is arranged parallel to and correspondingly externally distanced from the first or from the second row of retaining gudgeons.

A subtask of the invention is also solved by/through a method (according to claim 14) for inserting/embedding into the prosthesis parts the guide bushes or guide racks or the spring arms of the stabilizer.

Accordingly, the prosthesis parts to be equipped with the stabilizers according to the invention are fastened to each other, resting one atop the other in a position corresponding to that of the closed mouth, subsequent to which lateral, tubular recesses are introduced having into the rearward zone of both prosthesis parts, which recesses correspond to the intended progression of the stabilizer arms or the shape of the guide racks to be inserted, the corresponding depth and length of said recesses being achieved through grinding and/or milling. Of course, these tubular recesses or grooves for the guide bushes can each be inserted separately into the prosthesis parts prior to fastening the prosthesis parts to each other, after which insertion the prosthesis parts can be fastened to each other in the desired position.

In a further step, the previously described auxiliary device, which is equipped with two rows of gudgeons, is fitted with a guide rack above each row of gudgeons, upon which guide rack are then attached the rinsing hole tubes, after which said guide rack is then laterally inserted in a substantially horizontal sliding motion into the provided grooves of the prosthesis parts. By means of the handhold of the holding device, the entire holding construction, with both guide racks optimally positioned, can then be held and fixed until the remaining cavities of the grooves and the exteriors of the guide racks have been filled with appropriate material and said material has solidified. It must be noted at the same time that the insertion narrowings (mailbox slots) are each closed off against soiling, for example by one of the wedges that are inserted thereinto and are part of the assembly device. After sufficient hardening of the plastic that has been poured in, the auxiliary device is removed and the protruding ends of the rinsing hole tubes are cut off so as to be flush with the exterior of the prosthesis. A smoothing of the surfaces and the edges of the guide tubes and naturally also of the areas with the slot-shaped insertion holes is then finally conducted through polishing or repolishing. After completion of this work, only the rinsing holes and the insertion slots in the back are laterally visible from the outside. Subsequent to completion or the conclusion of positioning the guide parts on both prosthesis sides in the two prosthesis halves, both stabilizers can then quickly and easily be inserted through several movements, thereby making the dental prosthesis ready for use.

The following shall describe the invention in greater detail using one exemplary embodiment with reference to the drawings that show in

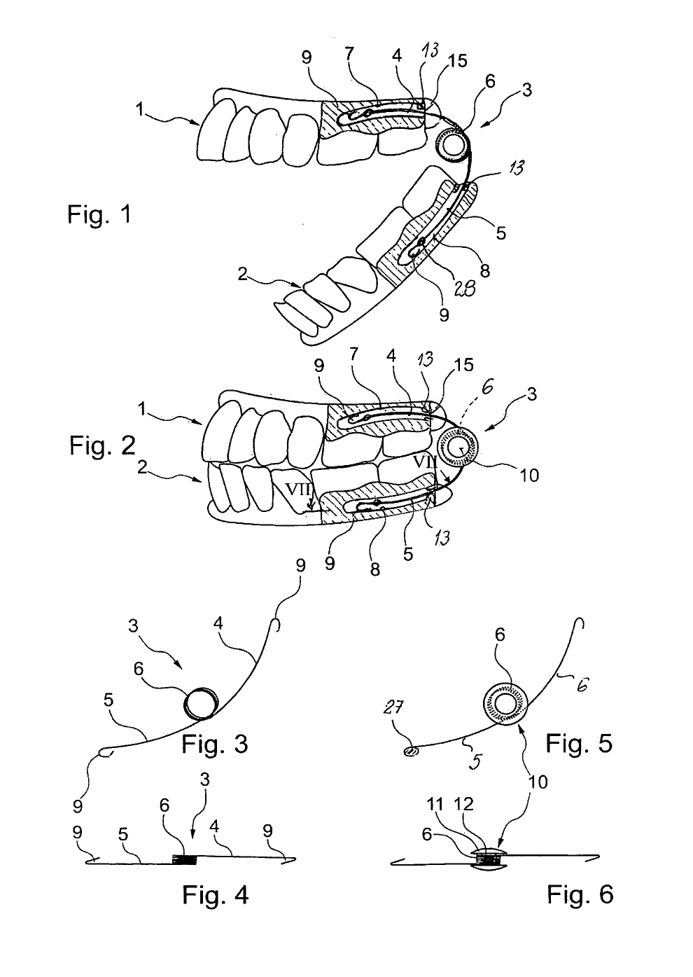

FIG. 1: a schematic side view of a prosthesis in an open state and with an inserted stabilizer;

FIG. 2: a view as in FIG. 1, the prosthesis parts in a closed state;

FIG. 3: a side view of a stabilizer spring;

FIG. 4: a plan view of the stabilizer spring according to FIG. 3;

FIG. 5: a side view as in FIG. 3, with inserted plastic spool;

FIG. 6: a plan view of the stabilizer of FIG. 5;

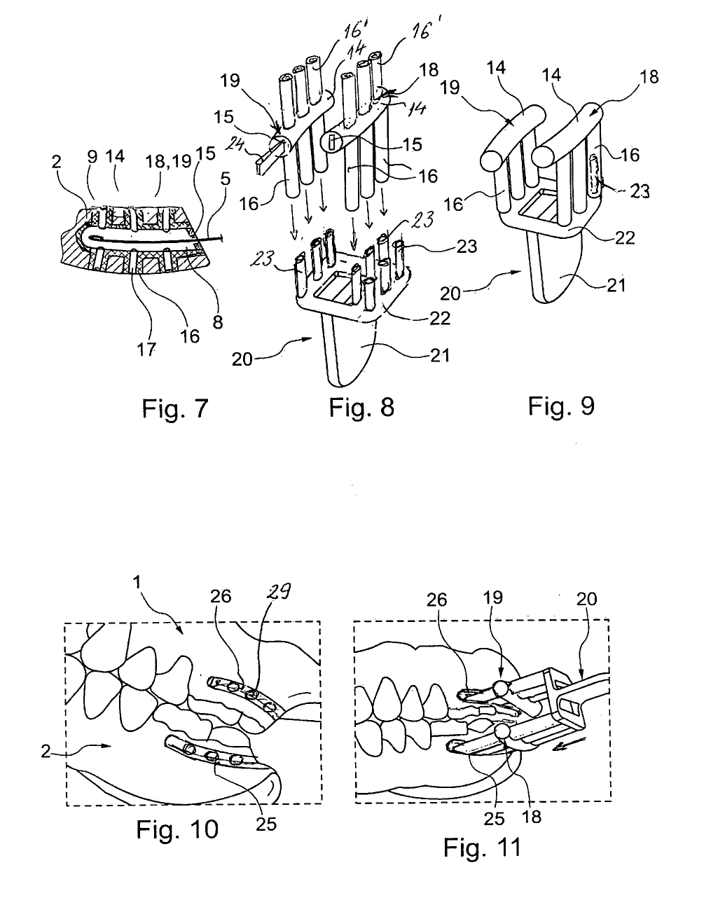

FIG. 7: a sectional view along lines VII-VII of FIG. 2, showing a design of the guide bore above a guide rack;

FIG. 8: a perspective exploded view of a holding/auxiliary device with two guide racks;

FIG. 9: a perspective view of the parts from FIG. 8, in an assembled state;

FIG. 10: a detail side view of the prosthesis parts with positioned tubular recesses;

FIG. 11: a view similar to that in FIG. 10, during insertion. The guide racks and the auxiliary device;

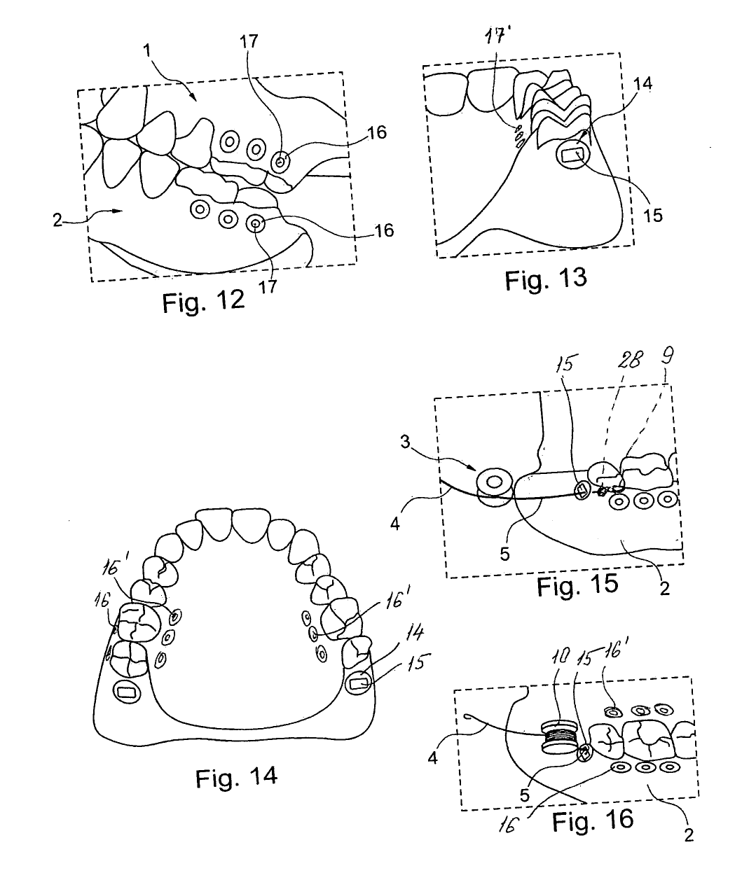

FIG. 12: a view similar to that in FIG. 10, however with completely positioned and embedded guide racks;

FIG. 13: a detail view from the rear with a completely positioned guide;

FIG. 14: a perspective view from the rear of a dental prosthesis with two completely positioned guides;

FIG. 15: a partial perspective view of a prosthesis part during insertion of a stabilizer arm through the insertion slot;

FIG. 16: a view similar to that in FIG. 15, now with the stabilizer swung 90° into the vertical functional position;

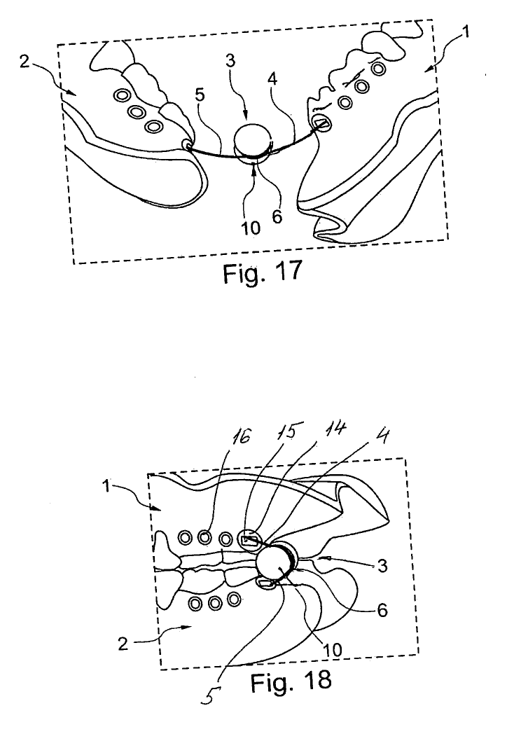

FIG. 17: a detail view of the rear of both prosthesis parts, each having an inserted stabilizer in the functional position, in an open prosthesis position, and

FIG. 18: a view of a situation as in FIG. 16, however both prosthesis parts being in a closed state, one atop the other.

It can be seen in FIGS. 1 and 2 how in a prosthesis consisting of an upper prosthesis part 1 and a lower prosthesis part 2, a stabilizer spring 3 is inserted and how it holds or can hold the prosthesis parts in a spring-like fashion, in a released state, slightly pushed apart. It can furthermore be seen how the stabilizer spring 3 is substantially represented as a double torsion spring consisting of two arms 4 and 5 which are flexibly held in a spring-loaded fashion by a joint that is nothing more than the coil spring part of the double torsion spring. The arms 4 and 5 are (in the broadest sense) telescopically designed in that they are axially movable in their arrangement in the cylindrical guides 7 and 8, which have a correspondingly curved design, in the prosthesis parts 1 and 2. The guides 7 and 8 are cylindrical (upswept) blind hole bores that are narrowed into insertion slots on their front, open end, in this instance through an external shoulder 13. The ends of the stabilizer arms 4 and 5 are each designed as a hook-shaped eyelet 9 or as a flat hook lying in approximately the same plane as that of the stabilizer arms, thus being located in a common vertical plane in the integrated state. During the process of attempting to remove the stabilizer 3 from the back of the prosthesis parts by simply pulling, the hook ends of the stabilizer arms 4, 5 glidingly remain on the respective vertical upper or lower wall sections of the guides 7, 8 by means of spring pressure, with their hook eyelets 9 hung or caught on the shoulders 13. Only a twisting and/or springy pressing together of the arm ends makes it possible for the exiting of the hook 9 through the narrowing of the insertion slot 15. A bead-shaped pellet 28 is arranged close to each eyelet 9, which pellet is marginally thicker (several tenths of a mm) than the width of the insertion slot 15, resulting in an elastic insertion or removal.

As can be particularly seen in FIG. 2, a facing 10 in the form of a plastic spool is provided on the spiral joint 6 of the stabilizer 3, which plastic spool protects the coil spring joint from general soiling while simultaneously protecting the wearer from uncomfortable effects caused by the coil spring of the joint (see also FIGS. 5 and 6). It is also illustrated how both stabilizer arms 4 and 5 and each accompanying guide bore 7 and 8 each have a different upsweep or curvature in order to make allowance for the specific movement of the mandible and thus also the sliding movement of the stabilizer arms. It should be noted that the lower stabilizer arm 5 and also the lower guide 8 exhibit a greater curvature or upsweep than the upper arm 4 and corresponding guide bore 7. In this manner, the lower arm 5 and the guide bore 8 follow at least more closely a curve of Spee, as is described in greater detail in document WO 2007/016753 A1.

FIGS. 3 and 4 show the stabilizer 3 in a released, non-integrated state. As previously described, said stabilizer consists of arms 4 and 5 onto the outer ends of which an eyelet 9 is bent while the inner zones of the arms are connected with the coil spring forming the joint 6. It can thus be stated that the stabilizer 3 is nothing other than a simple double torsion spring whose two protruding spring arms are provided with an eyelet in the same plane as the curved arms 4 and 5. It is self-evident that the stabilizer double torsion spring is designed in terms of material and dimensioning to ensure sufficient functional reliability, being particularly reliable in guiding and in keeping both prosthesis parts 1, 2 apart in a spring-loaded fashion. In this way, an undesired flipping open and closed is prevented as is also a pushing apart too strongly, which would cause the prosthesis wearer to always have to work against the spring resistance by squeezing the mouth shut or solidly pressing the jaws together.

In the design shown, FIGS. 5 and 6 show the same stabilizer as in FIG. 3, only that here, the facing 10, which is in the form of a plastic spool, is provided or placed on the joint 6. This spool-type of facing 10 has two mushroom-shaped flange parts 11 that are securely fastened or fastenable to each other by a foot part 12 that centrally passes through and fills the joint 6. The flange parts 11 are accordingly flush with both faces of the joint 6 and thereby prevent both impurities from entering the winding part of the joint 6 as well as direct contact with the movable spiral parts of the joint. Size and curvature of the flange parts 11 accordingly correspond approximately to that of a molar. Moreover, in FIG. 5, a flat, colored button 27 is positioned or fastened on the hook end of the arm 5, thereby making easily possible a color-coded allocation to a likewise correspondingly colored insertion slot.

In FIG. 7, which is a substantially horizontal view through the guide 8 (see FIG. 2), it is shown how the guide or the guide bore 8 is provided in a guide bush 14, which is straight in the horizontal plane while having in the vertical plane only a slight upsweep corresponding to the shape that can be seen in FIGS. 1 and 2. This guide bush 14 is closed on its insertion end except for a narrow insertion slot 15. It can be recognized in accordance therewith that this slot has a horizontal orientation, that is to say is substantially parallel to the chewing surface of the set of teeth. From the guide bush 14, rinsing tubes 16 open up to the outer side of the prosthesis and rinsing tubes 16′ open up to the inner side of the prosthesis, in which rinsing tubes rinsing holes 17 and 17′ are provided that join the interior of the guide bush 14 with the outer and inner sides of the prosthesis. In this way, saliva and food particles that have entered the guide bush 14 can very cleanly be washed away and/or exit again on their own or be pushed out again particularly through the sliding movement of the stabilizer arms in the bush interiors. It must be recognized that the tubular guide bush 14 forms a double-comb-shaped guide rack 18, 19 together with the rinsing tubes 16, 16′ integrally connected thereto.

FIG. 8 shows how the guide racks 18 and 19 are to be attached to an auxiliary device 20 in order to make possible an easier assembly or embedding in the prosthesis halves. The auxiliary device 20 consists of a handhold 21 on which a flange part 22 is provided on which, in turn, are arranged at least two rows of retaining gudgeons 23, in this instance three are shown. The number of retaining gudgeons 23 and their distance from one another and the row of three gudgeons from one another as well as the curved form of the row arrangement correspond to the form of the guides 7 in the dental prosthesis in solidly assembled work or insertion positioning for the guide racks 18, 19. For this purpose, both guide racks 18, 19 are here attached on the first two gudgeon rows while the free third gudgeon row, in this instance, can serve for attaching the guide rack 18 in the case of a large, high set of teeth. Moreover, the diameter of the gudgeons 23 is designed in such a manner that the guide racks 18, 19 can, by means of their rinsing tubes 16, be attached on the respective gudgeon rows, which here can be seen in the exploded representation of the three parts together, namely the auxiliary device and the two guide racks 18 and 19.

FIG. 9 illustrates a further work step, namely the situation in which both guide racks 18, 19 are, by means of their rinsing tubes 16, securely attached on the gudgeons 23 (for the sake of simplicity, only two gudgeon rows are shown and the guide racks have only one row of rinsing tubes 16) of the auxiliary device 20 until stopping. As already stated in connection with FIG. 8, it can now be recognized well in FIG. 9 how the guide bushes of both of the guide racks 18, 19 lie in precise alignment with one another with their curvature in the same plane by means of which an optimal, mutual handling is guaranteed upon insertion into the prosthesis parts.

In FIG. 10 it can be seen how, in order to fit the prosthesis parts 1, 2 one atop the other in a secure arrangement, a tubular recess 25 and 26 is provided in each of said prosthesis parts 1, 2, these recesses or grooves being respectively open in the lateral and rear sides of the prosthesis part. It is readily understood that in order to use double-combed guide racks, i.e. having rinsing tubes 16, 16′ provided on both sides, bores 29 leading inward must be positioned in the recesses 25, 26 for the insertion or reception of the second row of rinsing tubes 16′. Instead of that, it is possible for likewise traversing longitudinal slots to be provided instead of tubular recesses with bores.

FIG. 11 shows how both guide racks 18, 19 securely attached on/in the holding or auxiliary device are inserted into the two tubular recesses 25 and 26. It should be noted that the curved guide bushes 14 of the guide racks 18, 19 are insertable into the recesses 25, 26 with no problems. Not shown, however, is how the guide racks 18, 19 are inserted into the (straight or curved) recesses 25, 26 until reaching the depth stop (this is nevertheless easily understandable, even with double-comb guide racks) and how the remaining intermediate spaces between the guide racks and the recesses are thereafter plugged with suitable material. If slotted rather than tubular recesses 25, 26 are present, no stop exists and the guide bushes are to be positioned precisely in the slot by means of the auxiliary device and fixed therein with the filling material.

FIG. 12 shows the situation of the completed guide rack after having been integrally cast, the rinsing tube parts laterally protruding above the recesses (grooves) having already been worked away and the entire lateral surface together with corresponding edges having been smoothed and polished to the same fineness as the remaining prosthesis surfaces. Of the two guide racks, only the front faces of the external rinsing tubes 16 and the rinsing holes 17 found therein are visible and even that relatively indistinctly if the tube material has at least a similar color to that of the prosthesis body and the filling material.

FIG. 13 and also FIG. 14 respectively show a perspective view from the rear of half of a dental prosthesis and a perspective partial view from part of half of a prosthesis, in which are recognizable both the closed external faces of the guide bushes 14, except particularly for a horizontal insertion slot 15, and the rinsing holes 17.

FIG. 15 illustrates how a stabilizer 3 with its one arm 5 in a horizontal direction, that is to say in a direction in which the stabilizer planes, in which also the eyelets on the ends of the stabilizer arms lie, are in the same plane as the insertion slots 15 of the guide bushes, is inserted into the guide bush. It is recognizable how the insertion slot 15 simultaneously serves as a gliding channel or glide arrangement for the spring arm 5. Moreover, it is recognizable from a sketched dotted line how the pellet 28 near the eyelet 9 on the spring arm 5 would strike against the insertion slot 15 upon further outward sliding or pulling of the spring arm, thereby preventing an unintended slipping out.

FIG. 16 shows as a further step how the stabilizer arm 5 is substantially completely slid into the guide bush and swept approximately 90° to the extent that the stabilizer is now entirely in a vertical arrangement with regard to the lengthwise extension of the guide slot. A complete removal of the arm is now no longer possible since it, by means of its eyelet, is hooked on the interior face of the guide bush or insertion slot.

In FIG. 17 it is depicted how, by means of its arms 4 and 5 that are already in the prosthesis parts 1 and 2, the stabilizer 3 is inserted in the functional position, yet still in the open, as-of-yet-to-be-pushed-together, pretensioned functional position one atop the other.

Finally, FIG. 18 shows both of the prosthesis parts 1 and 2 in a state in which one is securely atop the other and furthermore with stabilizer 3 in the inserted functional position. It must be recognized that the joint 6 of the stabilizer is arranged very close to the rear faces of both prosthesis parts, directly behind both of the rows of teeth, and that the facing 10 in the form of a plastic spool pulled over the joint represents an optimally rounded closure.

### REFERENCE LIST

1. Upper prosthesis
2. Lower prosthesis
3. Stabilizer (spring)
4. (Stabilizer) arm
5. (Stabilizer) arm
6. Joint
7. Guide
8. Guide
9. Eyelet (hook) extension
10. Facing (plastic spool)
11. Flange part
12. Foot part
13. Shoulder
14. Guide bush
15. Insertion slot, narrowing
16. Rinsing tube
17. Rinsing hole
18. Guide rack
19. Guide rack
20. Auxiliary device
21. Handhold
22. Flange part
23. Retaining gudgeon
24. Wedge
25. Recess, tubular (groove)
26. Recess, tubular (groove)
27. Colored button
28. Pellet
29. Bores

1. A stabilizer for dental prostheses with:
two arms that are jointedly connected to each other and simultaneously represent the long, curved arms of a torsion spring in such a manner that the stabilizer arms can easily be held pushed apart from one another,
the arms being telescopically and axially movable in correspondingly curved or upswept cylindrical guides that are provided in the prosthesis halves along the rows of teeth,
characterized in that
the guides (7, 8) are closed on the face on the outer insertion end except for a narrow narrowing, for example a narrow insertion slot (15) in the style of a mailbox slot, approximately parallel to the chewing surface,
the ends of the arms (4, 5) have extensions, for example flat ones in the style of an eyelet (9), a loop or a bow, or balls or the like and are dimensioned in such a manner that they are insertable through this narrowing insertion slot (15) of the guides (7, 8).

2. The stabilizer as specified in claim 1, characterized in that in designing the ends of the arms (4, 5) with flat extensions in the style of an eyelet in the integral functional position of the stabilizer (3), the extensions such as eyelets, or the eyelet planes, are arranged at an angle of approximately 90°±20° to the longitudinal extension of the insertion slot.

3. The stabilizer as specified in claim 1, characterized in that the narrowing (15) is shaped, for example, as an insertion slot in the style of a centric mailbox slot, as a vertically staggered slot corresponding to a vertically external shoulder, i.e. upper and lower, as a latch, as a spring-loaded pin, or as an elastic slotted membrane, each also designed with different colors.

4. The stabilizer as specified in claim 1, characterized in that the extension (9) on the ends of the arms (4, 5) is designed, for example, as a hook, eyelet, curve, flattening, ball, small panel, button, flatly arranged button, drop-shaped, each also having different colors, and are parts that are shaped from the wiry material of the arms or are separate parts subsequently attached or positioned on the ends of the arms.

5. The stabilizer as specified in claim 1, characterized in that the eyelets (9) or primarily closed hooks are minimally wider than the length of the insertion slot and latch into or out of place with give upon removal or when being guided with pushing or pulling.

6. The stabilizer as specified in claim 1, characterized in that a bead-shaped pellet (28), which is in the form of a ball, cylinder or spherical cap composed of glass, plastic or stainless steel, is securely fixed on the spring arms (4, 5) near the eyelets (9), is several tenths of a mm thicker than the width of the insertion slot 15, is clampingly slid on or attached to the straight arm ends for sliding in and out under resistance in the form of a latch, the pellet (28) is applied to the arm or is a self-contained part along with the allocated eyelet.

7. The stabilizer as specified in claim 1, characterized in that the guide (7, 8) is part of a tubular guide bush (14) that is embedded in the prosthesis material in such a manner that its external insertion end terminates with its face terminating on the rear side of the separate prosthesis side, preferably flush therewith.

8. The stabilizer as specified in claim 7, characterized in that the guide bush (14) is a plastic tube the interior of which is connected to at least the exterior, preferably also the interior of the prosthesis parts by means of its at least one, preferably three, holes or radial lateral openings, thereby forming rinsing holes (17) or ventilation holes.

9. The stabilizer as specified in claim 8, characterized in that the rinsing holes (17) are also made of plastic tubes (16, 16′) that are connected to the tubular guide bush (14), preferably being formed integrally therewith, thereby forming a one-sided guide rack or a double guide rack (18, 19).

10. The stabilizer as specified in claim 1, characterized in that joint (6) of the stabilizer (3), i.e. the windings of the torsion spring, is axially held and/or enveloped by a facing (10) in the form of a plastic spool.

11. The stabilizer as specified in claim 10, characterized in that the facing (10) consists of two flange parts (11) that are formed in the style of a snap fastener and can be axially pressed together and locked in place in such a manner that the heads of the flange parts (11) envelop the outside or front faces of the springs and axially hold the spiral windings together at a predetermined measurement, the size/surface and curvature of the flange parts corresponding approximately to that of the last molar.

12. The stabilizer as specified in claim 1, characterized in that the extensions/hooks/eyes/loops of the spring arms (4, 5) of the stabilizer (3) are arranged or curved in the same bending plane as those of the arms (4, 5).

13. An auxiliary device for positioning and holding the guide racks with rinsing holes during embedding in the prosthesis parts, characterized in that it has a handhold on the front end of which a flange part (22) is provided an which at least two rows of vertically protruding retaining gudgeons (23) (pegs) are provided, in the same number and distance to each other as with the rinsing tubes, the retaining gudgeons having substantially the same external measurements as the interior measurements of the rinsing holes an are also adjusted to them with regard to length.

14. The auxiliary device as specified in claim 13, characterized in that at least a third row of retaining gudgeons (23) is still provided corresponding to the foreseeable greater distances between the recesses (25, 26) in a larger set of teeth.

15. A method for inserting/embedding the guide bushes or racks for the spring arms of the stabilizer into the prosthesis parts (1, 2) having the following steps:
fixing the prosthesis parts in a position one atop the other corresponding to a closed-mouth situation,
introducing by grinding or milling a slotted or tubular, preferably upswept, recess (25, 26) on the rearward external sides of both prosthesis halves (1, 2) above and below the rows of teeth,
attaching both of the guide racks (18, 19), i.e. the upper and the lower upswept guide tube racks, on the correspondingly arranged distanced retaining gudgeon (23) of the auxiliary device as specified in claim 10, in such a manner that they are precisely in position with regard to one another in the assembled state in the closed, or resting one atop the other, prosthesis position,
inserting the guide racks (18, 19) that are attached on the auxiliary device into both of the slotted or tubular recesses (25, 26) on the respective external side of prosthesis halves positioned one atop the other and correctly positioned holding or fixing of the handhold (21) of the auxiliary device (20),
plugging the intermediate spaces between the (up to the limit stop) inserted guide racks (18, 19) and the recesses (25, 26),
after hardening of the poured-in plastic, removing of the auxiliary device (20) and flush trimming of the rinsing tubes (16) protruding from the lateral surfaces of the prosthesis halves, and subsequent repolishing of the surfaces.

16. The method as specified in claim 15, characterized in that the tubular recesses (25, 26) are already positioned prior to the fixing of the prosthesis parts to each other.

17. The method as specified in claim 15, characterized in that upon using double guide racks (18, 19), the recesses (25, 26) are designed as continuous slots or as channels that are open on only one side or are laterally open and in whose rear or internal wall bores are introduced for receiving the internal rinsing tubes (16′), which bores lead into the interior of the dental prosthesis.
